(19) United States
(12) Patent Application Publication
(10) Pub. No.: US 2015/0172477 A1
(43) Pub. Date: Jun. 18, 2015

(54) IMAGE FORMING APPARATUS, MAINTENANCE PROCEDURE PRESENTATION METHOD, AND COMPUTER PROGRAM

(71) Applicant: CANON KABUSHIKI KAISHA, Tokyo (JP)

(72) Inventor: Jun Yamamoto, Kawasaki-shi (JP)

(21) Appl. No.: 14/566,577

(22) Filed: Dec. 10, 2014

(30) Foreign Application Priority Data
Dec. 17, 2013 (JP) 2013-260436

(51) Int. Cl. H04N 1/00

(52) U.S. Cl. CPC H04N 1/00076; H04N 1/00037; H04N 1/00015; H04N 1/00018; H04N 1/0048; H04N 2201/0003; H04N 2201/0094; H04N 2201/0098

(57) ABSTRACT

An image forming apparatus includes a display unit for displaying a moving image indicating a maintenance procedure. When a moving image is stopped, a CPU 101 displays one or more operation marks for operating the stopped moving image on the display unit by overlapping with the moving image, and hides all of the operation marks when a certain period of time elapses from display of the operation mark. If all of the operation marks are hidden during when the moving image is stopped, the CPU redisplays the operation mark in response to a user operation. If one operation mark is displayed during when the moving image is stopped, the CPU reproduces the stopped moving image in response to a user operation.

### BACKGROUND OF THE INVENTION

1. Field of the Invention

The present invention relates to a maintenance technique for an image forming apparatus, such as a copying machine and a multifunction peripheral.

2. Description of the Related Art

Some image forming apparatuses display an image indicating a maintenance procedure on a display unit including a display, such as a liquid crystal display (LCD), when maintenance, like release of a paper jam and refill of a toner, is required. An image to be displayed on the display unit may be a moving image. In the case of displaying a moving image, high expressiveness and voluminous information thereof enable a user to smoothly perform maintenance of the apparatus.

An image forming apparatus includes a high-capacity storage medium, such as a hard disk drive (HDD). An image (a moving image) indicating a maintenance procedure is stored in the HDD and reproduced if needed. The image indicating the maintenance procedure may be stored in another apparatus such as a server. Japanese Patent Application Laid-Open No. 2008-282217 discusses a technique in which an image indicating a maintenance procedure is stored in an apparatus and an image forming apparatus downloads the image therefrom via a network and presents the image if necessary.

A moving image indicating such a maintenance procedure is stored as one piece of data for each content of maintenance. For example, a maintenance procedure for releasing a jam includes an operation for opening a cover to access a jam occurrence point in the image forming apparatus, an operation for removing a jammed sheet, and an operation for closing the door, and moving images indicating each of the operations are regarded as one piece of data.

A display unit of an image forming apparatus usually includes a small display screen. When the display screen is a touch panel type, operation buttons and operation marks (or icons) to be displayed on the display screen for a user input operation inevitably become small. Japanese Patent Application Laid-Open No. 2009-163345 discusses an input apparatus for improving an operability by hiding operation buttons and operation marks in an operable state to extend an operable area without interrupting viewing of a user when contents like moving images and pictures are viewed in a small display screen.

A moving image indicating a maintenance procedure is aimed at all users who perform maintenance. Therefore, the moving image is also presented to a user who does not regularly operate moving images in a positive manner. To such a user, an operation button and an operation mark corresponding to the moving image need to be explicitly displayed on a position easy to understand. For example, it is necessary to display a reproduction button by overlapping on a paused moving image to indicate that the moving image can be reproduced again.

However, when an operation button and an operation mark are explicitly displayed, a part of the image is hidden by the operation button and the operation mark. Thus, if a user wants to look at a screen in detail by temporarily stopping the image, the operation button and the operation mark may sometimes hide a part that the user wants to view. If the operation button and the operation mark can be explicitly displayed and also an image can be displayed without being hidden by them at the time of temporary stop, any user can check a maintenance procedure, and thus the operability can be improved.

The present invention is directed to the provision of an image forming apparatus capable of presenting a moving image indicating a maintenance procedure to any user without impairing the operability to solve the above-described issue.

### SUMMARY OF THE INVENTION

According to an aspect of the present invention, an image forming apparatus includes a display unit configured to display a moving image indicating a maintenance procedure, an overlapping display unit configured to, in a case where the moving image is stopped, display one or more operation marks for operating the stopped moving image on the display unit by overlapping with the moving image, a hiding unit configured to hide all of the operation marks in a case where a predetermined condition is satisfied during when the operation mark is displayed, and a control unit configured to, in a case where all of the operation marks are hidden during when the moving image is stopped, redisplay the one or more operation marks by the overlapping display unit in response to a user operation, and in a case where one operation mark is displayed during when the moving image is stopped, operate the stopped moving image according to the operation mark in response to a user operation.

Further features of the present invention will become apparent from the following description of exemplary embodiments with reference to the attached drawings.

### BRIEF DESCRIPTION OF THE DRAWINGS

FIG. 1 is a function configuration drawing of an image forming apparatus.

FIG. 2 is an outline view of an image forming apparatus.

FIG. 3 is an internal configuration drawing of a printer.

FIG. 4 is an example of management tables of moving images.

FIGS. 5A to 5F illustrate examples of images to be displayed on a display unit.

FIG. 6 is a flowchart illustrating processing for presenting a maintenance procedure.

FIGS. 7A to 7C illustrate display examples of operation marks.

FIGS. 8A-1 to 8B-3 illustrate how an operation mark is hidden.

FIG. 9 is a flowchart illustrating processing for hiding an operation mark.

FIG. 10 is a flowchart illustrating processing for hiding an operation mark.

FIG. 11 is a flowchart illustrating processing for hiding an operation mark.

FIG. 12 is a flowchart illustrating processing for redisplaying an operation mark.

FIG. 13 is a flowchart illustrating processing for redisplaying an operation mark.

FIG. 14 is a flowchart illustrating processing for redisplaying an operation mark.

FIG. 15 is an outline view of an input unit.

FIG. 16 is a flowchart illustrating processing for switching display and non-display of an operation mark.

FIG. 17 illustrates an example of a selection window.

FIG. 18 is a flowchart illustrating processing for switching display and non-display of an operation mark.

FIGS. 19A and 19B illustrate a drag operation of an operation mark.

FIG. 20 is a flowchart illustrating processing for switching display and non-display of an operation mark.

### DESCRIPTION OF THE EMBODIMENTS

Exemplary embodiments, features, and aspects of the invention will be described in detail below with reference to the drawings.

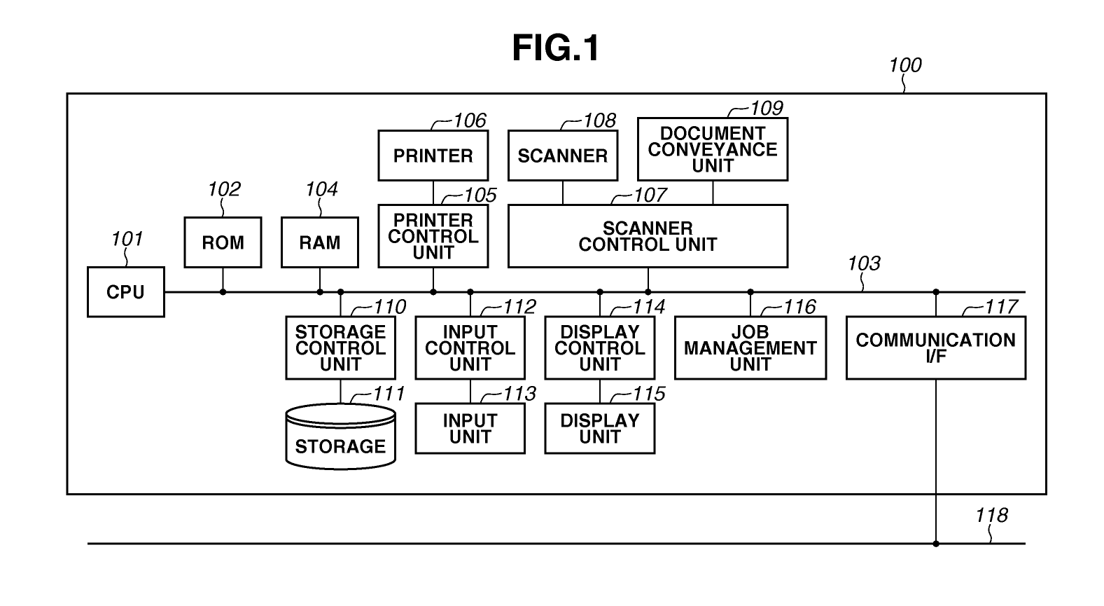

FIG. 1 is a function configuration drawing for realizing functions of an image forming apparatus according to a first exemplary embodiment. An image forming apparatus 100 includes a printer 106 and a scanner 108. The image forming apparatus 100 can copy a document by causing the printer 106 to print an image of the document read by the scanner 108, for example.

The image forming apparatus 100 as described above is entirely controlled by a central processing unit (CPU) 101. The CPU 101 starts up an operating system (OS) by executing a boot program stored in a read only memory (ROM) 102. The CPU 101 controls the image forming apparatus 100 by executing a computer program stored in a storage 111 on the OS. A random access memory (RAM) 104 serves as a work area when the CPU 101 executes various programs.

A printer control unit 105 controls the printer 106 to perform processing for forming an image on a sheet. A scanner control unit 107 controls the scanner 108 to perform processing for reading a document image. The scanner control unit 107 also controls an operation of a document conveyance unit 109, such as an auto document feeder (ADF). The scanner control unit 107 conveys a document sheet by sheet from the document conveyance unit 109 to the scanner 108 at the time of reading the document. Thus, the scanner 108 can continuously read a plurality of sheets of the document one by one. The scanner 108 reads a document image by scanning on the document using an optical reading element, such as a charge coupled device (CCD) sensor.

A storage control unit 110 reads out data and various programs from the storage 111 and writes data thereinto. The storage 111 is a high capacity non-volatile storage medium, like a HDD, and stores various pieces of data, such as a moving image indicating a maintenance procedure, in addition to the various programs.

An input control unit 112 receives an operation instruction of a user input from an input unit 113, such as a touch panel and a hard key. A display control unit 114 controls a display unit 115 including a display, such as an LCD and a cathode ray tube (CRT), to display an operation screen and a moving image.

A job management unit 116 stores and manages job information in the RAM 104 and the storage 111. The job information includes job settings such as a start time, a job type, a document name, a number of output copies, and presence or absence of stapling of a job being processed by the image forming apparatus 100. If a job is input, the CPU 101 stores job information of the job in the job management unit 116. A job type includes, for example, copy, print, transmission, storage, and the like, which are a type of a job that the image forming apparatus 100 can execute. A communication interface (I/F) 117 is controlled by the CPU 101 to perform communication control via a network 118 including a local area network (LAN), the internet, wired communication, a wireless communication, and the like.

Each component of the image forming apparatus 100 is communicably connected to one another via a bus 103.

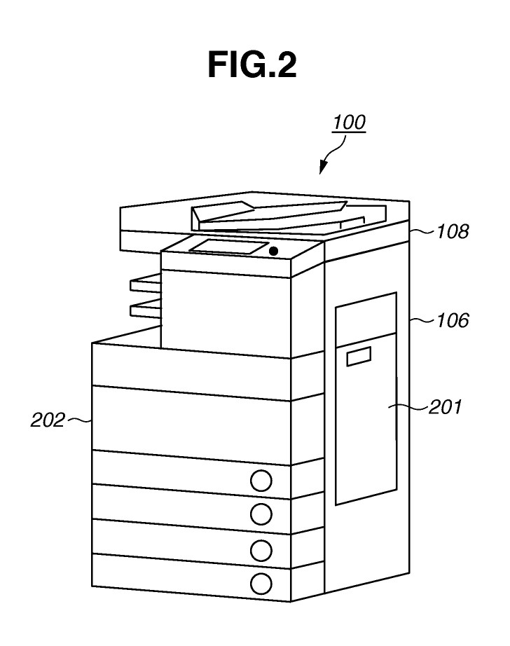

FIG. 2 is an outline view of the image forming apparatus 100. The image forming apparatus 100 has an arrangement in which the scanner 108 is located above the printer 106. The image forming apparatus 100 includes a right cover 201 for exposing a sheet conveyance path in the image forming apparatus 100 to remove a jammed sheet and a toner cover 202 for exposing a mounting unit of a toner cartridge when toner is replaced. The right cover 201 and the toner cover 202 respectively include an opening and closing detection sensor for detecting an open and close state of the cover. The opening and closing detection sensor may be the one using a mechanical flag and the one using an optical element.

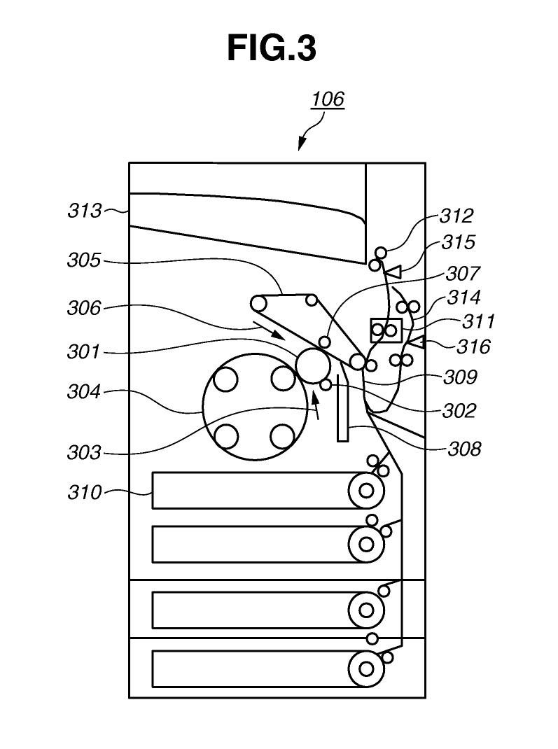

FIG. 3 is an internal configuration drawing of the printer 106. The printer 106 has a configuration capable of forming an image in full color.

The printer 106 performs image forming processing on a sheet using a photosensitive drum 301, a rotary development device 304, and an intermediate transfer belt 305. The photosensitive drum 301 is charged by a primary charging device 302 and exposed to light by an exposure device, which is not illustrated, at a position indicated by an arrow 303. Exposure by the exposure device is controlled according to an image to be formed. An electrostatic latent image corresponding to one color is formed on the photosensitive drum 301 by exposure.

The rotary development device 304 includes four development devices integrated with toner cartridges. On the photosensitive drum 301, one of the development devices in the rotary development device 304 applies a toner to the electrostatic latent image, so that a toner image is formed.

The intermediate transfer belt 305 is driven to a direction indicated by an arrow 306. The toner image formed on the photosensitive drum 301 is transferred from the photosensitive drum 301 to the intermediate transfer belt 305 at a contact position between the photosensitive drum 301 and the intermediate transfer belt 305 by an electric field generated by a primary transfer roller 307. A surface of the photosensitive drum 301 is cleaned by a cleaner 308 after the toner image is transferred to the intermediate transfer belt 305. A series of processing from forming an electrostatic latent image, development, transfer, to cleaning is repeated, so that images in four colors (magenta, cyan, yellow, and black) are transferred to the intermediate transfer belt 305 by being overlapped with each other and thus a full color image is formed. In the case of a single color image, a series of processing from forming an electrostatic latent image, development, transfer, to cleaning is performed only once.

The image transferred to the intermediate transfer belt 305 is transferred to a sheet supplied from a cassette 310 by a secondary transfer roller 309. The sheet on which the image is transferred is conveyed to a fixing device 311. The fixing device 311 applies heat and pressure to the sheet on which the image is transferred and fixes the image onto the sheet. When the fixing processing is finished, the sheet is conveyed by a discharging roller 312 to a discharging port 313 and discharged to the outside of the printer 106. In the case of double-sided printing, a sheet subjected to the fixing processing is circulated by passing through a reversing path 314, and the above-described processing is repeated.

A sheet discharging unit sensor 315 is installed in a conveyance path between the fixing device 311 and the discharging roller 312. In the reversing path 314, a double-sided unit sensor 316 is installed. Both of the sheet discharging unit sensor 315 and the double-sided unit sensor 316 detect whether a sheet is stagnated or not. Thus, the sheet discharging unit sensor 315 and the double-sided unit sensor 316 can detect a jam of a sheet. The sheet discharging unit sensor 315 and the double-sided unit sensor 316 may be the one using a mechanical flag and the one using an optical element.

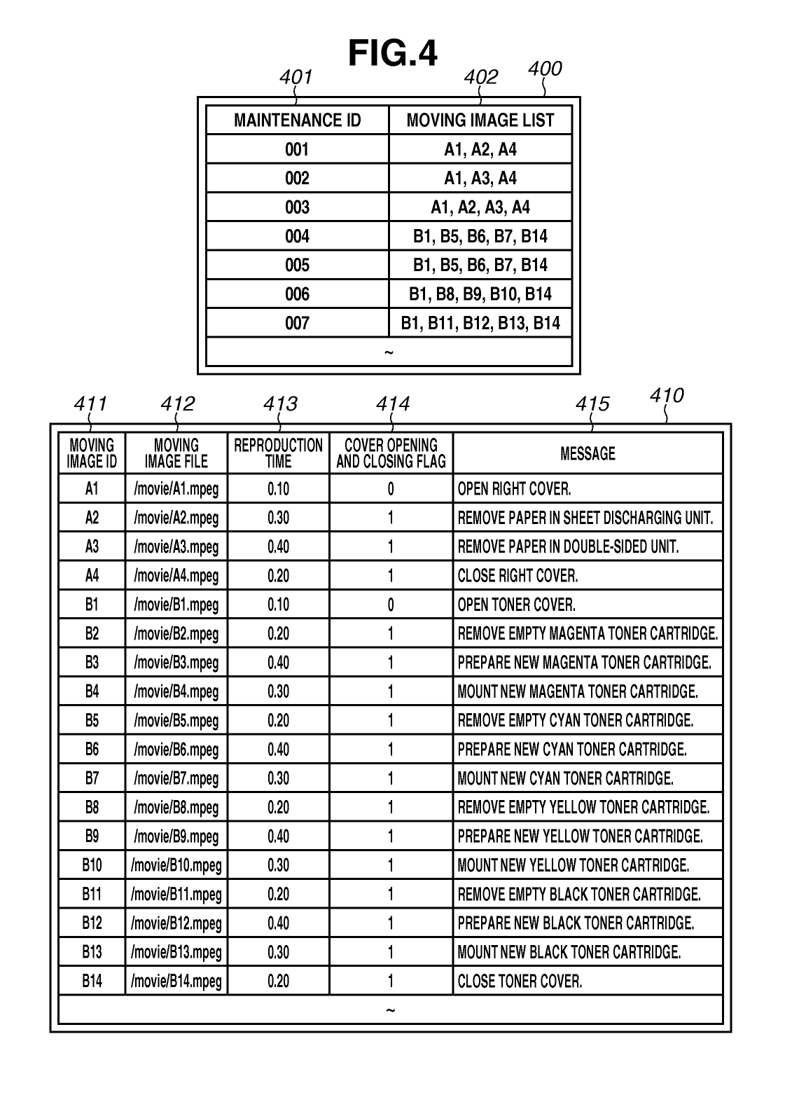

FIG. 4 illustrates an example of management tables of moving images indicating a maintenance procedure to be presented to a user when maintenance of the image forming apparatus 100 is performed. The management table includes a moving image list table 400 and a moving image table 410. The moving image list table 400 and the moving image table 410 are stored in the storage 111. In the image forming apparatus 100, a state requiring maintenance is referred to as a “maintenance state”. An identifier for identifying a maintenance state is referred to as a “maintenance identification (ID)”. An identifier for identifying a moving image is referred to as a “moving image ID”.

The moving image list table 400 defines a relationship between a maintenance state and a moving image to be reproduced when the maintenance state occurs. The moving image list table 400 includes a data item 401 and a data item 402. The data item 401 stores a maintenance ID. The data item 402 stores a moving image list which is a list of moving image IDs of moving images to be reproduced when the maintenance state indicated in the data item 401 occurs. Moving images are reproduced in an order in the moving image list. The maintenance ID stored in the data item 401 of the moving image list table 400 indicates following maintenance states, for example.

A maintenance ID “001” indicates a jam in a sheet discharging unit (a sheet discharging unit jam). When the sheet discharging unit sensor 315 detects stagnation of a sheet, it is determined that the sheet discharging unit jam has occurred. A maintenance ID “002” indicates a jam in a double-sided unit (a double-sided unit jam). When the double-sided unit sensor 316 detects stagnation of a sheet, it is determined that the double-sided unit jam has occurred. A maintenance ID “003” indicates the sheet discharging unit jam and the double-sided unit jam. When both of the sheet discharging unit sensor 315 and the double-sided unit sensor 316 detect stagnation of a sheet, it is determined that a state of the maintenance ID “003” has occurred.

A maintenance ID “004” indicates replacement of a magenta toner cartridge. When the printer control unit 105 detects that a magenta toner is empty, it is determined that a state of the maintenance ID “004” has occurred. A maintenance ID “005” indicates replacement of a cyan toner cartridge. When the printer control unit 105 detects that a cyan toner is empty, it is determined that a state of the maintenance ID “005” has occurred. A maintenance ID “006” indicates replacement of a yellow toner cartridge. When the printer control unit 105 detects that a yellow toner is empty, it is determined that a state of the maintenance ID “006” has occurred. A maintenance ID “007” indicates replacement of a black toner cartridge. When the printer control unit 105 detects that a black toner is empty, it is determined that a state of the maintenance ID “007” has occurred.

The moving image table 410 defines information of a moving image. The moving image table 410 includes data items 411 to 415. The data item 411 stores the moving image ID. The moving image ID of the data item 411 is specified by the moving image ID stored in the data item 402 of the moving image list table 400. The data item 412 stores a file name of the moving image identified by the moving image ID. The data item 413 stores a reproduction time length of the moving image.

The data item 414 stores a cover opening and closing flag indicating that the moving image is the one presenting a procedure before the cover (the right cover 201 and the toner cover 202) of the image forming apparatus 100 is opened or after the cover is opened. When the cover opening and closing flag is “0”, it indicates the procedure before the cover is opened. When the cover opening and closing flag is “1”, it indicates the procedure after the cover is opened. The data item 415 stores a message for complementing contents of maintenance work which is displayed when the moving image is reproduced.

The moving image table 410 defines information pieces about, for example, following moving images.

A moving image ID “A1” indicates a moving image of opening the right cover 201 of the printer 106. A moving image ID “A2” indicates a moving image of removing a sheet (jammed sheet) jammed near the sheet discharging unit sensor 315. A moving image ID “A3” indicates a moving image of removing a jammed sheet near the double-sided unit sensor 316. A moving image ID “A4” indicates a moving image of closing the right cover 201 of the printer 106.

A moving image ID “B1” indicates a moving image of opening the toner cover 202 of the printer 106. A moving image ID “B2” indicates a moving image of removing an empty magenta toner cartridge from the printer 106. A moving image ID “B3” indicates a moving image of preparing a new magenta toner cartridge. A moving image ID “B4” indicates a moving image of mounting a new magenta toner cartridge to the printer 106.

A moving image ID “B5” indicates a moving image of removing an empty cyan toner cartridge from the printer 106. A moving image ID “B6” indicates a moving image of preparing a new cyan toner cartridge. A moving image ID “B7” indicates a moving image of mounting a new cyan toner cartridge to the printer 106.

A moving image ID “B8” indicates a moving image of removing an empty yellow toner cartridge from the printer 106. A moving image ID “B9” indicates a moving image of preparing a new yellow toner cartridge. A moving image ID “B10” indicates a moving image of mounting a new yellow toner cartridge to the printer 106.

A moving image ID “B11” indicates a moving image of removing an empty black toner cartridge from the printer 106. A moving image ID “B12” indicates a moving image of preparing a new black toner cartridge. A moving image ID “B13” indicates a moving image of mounting a new black toner cartridge to the printer 106. A moving image ID “B14” indicates a moving image of closing the toner cover 202 of the printer 106.

According to the above described management tables, for example, when a sheet discharging unit jam occurs, the moving image list “A1, A2, and A3” in the maintenance ID “001” is selected and the moving images are reproduced in the order of the moving image IDs “A1”, “A2”, and “A3”. Thus, the moving image corresponding to the maintenance procedure is reproduced using the management table.

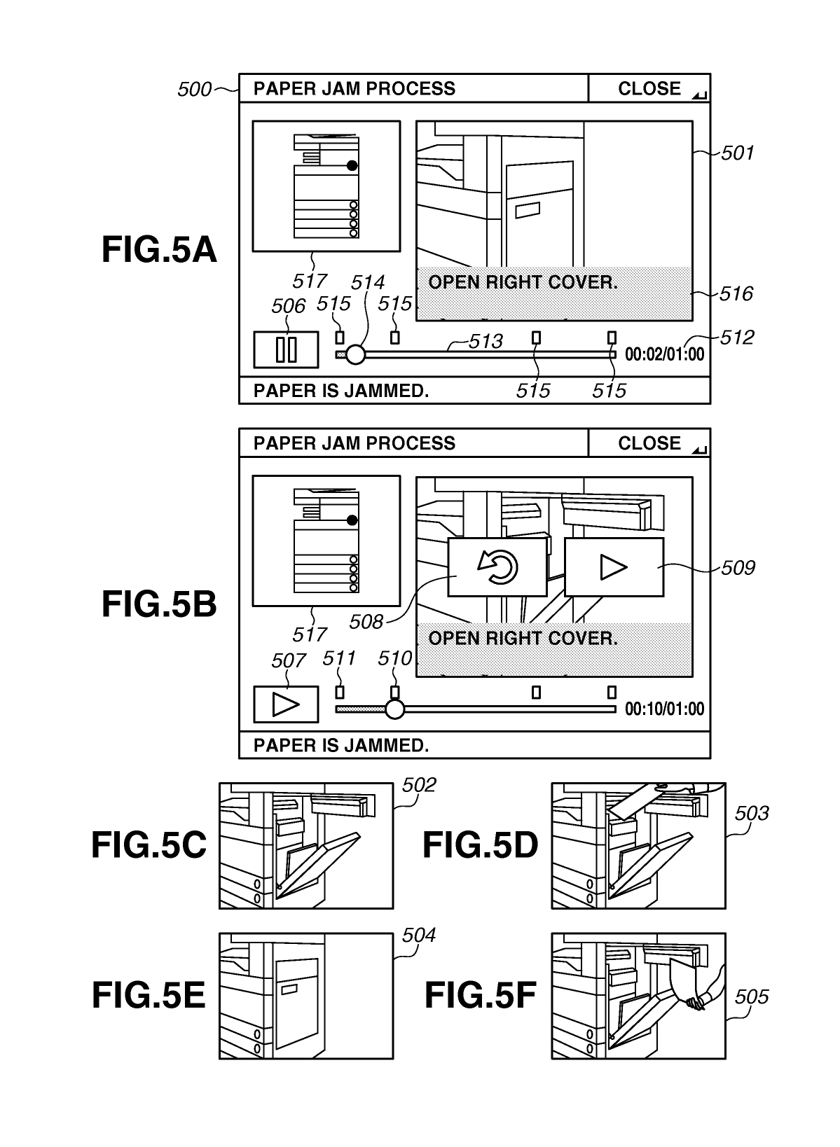

FIGS. 5A to 5F are examples of images to be displayed on the display unit 115. An image generated by the CPU 101 based on a program and data stored in the storage 111 is displayed on the display unit 115 by the display control unit 114. In FIGS. 5A to 5F, states indicated by the maintenance IDs “001” (a sheet discharging unit jam) and “002”(a double-sided unit jam) are exemplified. FIG. 5A indicates an image when a moving image is reproduces. FIG. 5B indicates an image when the moving image is stopped. FIGS. 5C to 5F are display examples of a moving image display area 501.

An image 500 is a whole image displayed on the display unit 115 when the apparatus is in the maintenance state. The image 500 includes the moving image display area 501 in which a moving image indicating a maintenance procedure is displayed. The CPU 101 displays a moving image in the moving image display area 501 according to the maintenance procedure.

For example, in the case of a maintenance state of a sheet discharging unit jam (the maintenance ID “001”), the CPU 101 first displays a moving image 502 illustrated in FIG. 5C in the moving image display area 501. The moving image 502 is the one identified by the moving image ID “A1” (i.e., opening the right cover 201). When reproduction of the moving image 502 having the moving image ID “A1” is finished, the CPU 101 displays a moving image 503 illustrated in FIG. 5D in the moving image display area 501. The moving image 503 is the one identified by the moving image ID “A2” (i.e., removing a jammed sheet near the sheet discharging unit sensor 315). When reproduction of the moving image 503 having the moving image ID “A2” is finished, the CPU 101 last displays a moving image 504 illustrated in FIG. 5E in the moving image display area 501. The moving image 504 is the one identified by the moving image ID “A4” (i.e., closing the right cover 201).

In the case of a double-sided unit jam (the maintenance ID “002”), the CPU 101 displays moving images in the order of the moving image IDs “A1”, “A3”, and “A4” in the moving image display area 501. FIG. 5F is a display example of a moving image 505 identified by the moving image ID “A3” (i.e., removing a jammed sheet near the double-sided unit sensor 316). In the moving image display area 501, moving images are displayed in the order of FIG. 5C, FIG. 5F, and FIG. 5E.

A pause button 506 in the image 500 is a button for instructing temporary stop of a moving image being reproduced. When the pause button 506 is operated and the reproduction of the moving image is temporarily stopped, the CPU 101 hides the pause button 506 and displays a reproduction button 507 (FIG. 5B) at a position where the pause button 506 has been displayed. If the reproduction button 507 is operated, the CPU 101 reproduces the moving image. In addition, the CPU 101 displays one or more operation marks for operating the moving image being stopped in the moving image display area 501 by overlapping with the moving image. According to the present exemplary embodiment, two marks, namely a replay mark 508 and a reproduction mark 509 are displayed as the operation marks by being overlapped with the moving image. The reproduction mark 509 is a button for instructing reproduction of the stopped moving image as with the reproduction button 507. When the reproduction mark 509 is operated, the CPU 101 starts reproduction of the moving image. The replay mark 508 is a button for reproducing the stopped moving image from the beginning again. More specifically, if the replay mark 508 is operated when the moving image is stopped at a position of a chapter 510, the CPU 101 reproduces the moving image from a position of a chapter 511. When the reproduction of the moving image is started, the CPU 101 hides the reproduction button 507 and the operation marks and displays the pause button 506.

A reproduction time display label 512 in the image 500 indicates a sum of reproduction time lengths of the moving images indicating the maintenance procedure (i.e., total reproduction time) and a time point of a current reproducing position with respect to the total reproduction time (i.e., reproduction position time). The total reproduction time and the reproduction position time are described using a case of the maintenance ID “001” as an example.

According to the moving image list table 400, in the case of the maintenance ID “001”, moving images having the moving image IDs “A1”, “A2”, and “A4” are reproduced as the moving images indicating the maintenance procedure. According to the moving image table 410, a reproduction time of a moving image having the moving image ID “A1” is “10 seconds”, a reproduction time of a moving image having the moving image ID “A2” is “30 seconds”, a reproduction time of a moving image having the moving image ID “A4” is “20 seconds”, and thus the total reproduction time will be “1 minute”.

The reproduction position time indicates a current reproduction position with respect to the total reproduction time. Thus, for example, in the case that a scene which is “5 seconds” passed from a beginning of a moving image reproduced in first (a moving image having the moving image ID “A1”) is currently displayed, “5 seconds” directly becomes the reproduction position time. In the case that a scene which is “10 seconds” passed from a beginning of a moving image reproduced in second (a moving image having the moving image ID “A2”) is currently displayed, since reproduction of the moving image having the moving image ID “A1” has been finished, a current reproduction time of the moving image is added to the reproduction time of the moving image ID “A1”. Therefore, in this example, the reproduction position time becomes “20 seconds”.

The reproduction time display label 512 displays the reproduction position time and the total reproduction time which are calculated in the above-described manner. In FIGS. 5A and 5B, the reproduction time display label 512 is displayed as a format of (reproduction position time/total reproduction time). In FIG. 5A, the reproduction position time is “2 seconds” (00:02), and the total reproduction time is “1 minute” (01:00).

A bar 513 and a slider 514 in the image 500 indicate a reproduction position in the entire moving image and serve as a seek bar for inputting an instruction to move the reproduction position. The bar 513 schematically indicates a total reproduction time. A position of the slider 514 indicates a reproduction position time. The slider 514 moves within a range from a left end to a right end of the bar 513 according to a reproduction state (a reproduction position time) of a moving image and does not move beyond the range. When an arbitrary position on the bar 513 is pressed, a reproduction position of a moving image can be advanced to the pressed position at once, and the slider 514 also moves to that position.

A chapter 515 in the image 500 indicates a break position of each scene in a moving image based on the moving image list table 400 and the moving image table 410. The chapter 515 is described using the case of the maintenance ID “001” as an example. According to the moving image list table 400, in the case of the maintenance ID “001”, moving images having the moving image IDs “A1”, “A2”, and “A4” are reproduced. According to the moving image table 410, a reproduction time of a moving image having the moving image ID “A1” is “10 seconds”, a reproduction time of a moving image having the moving image ID “A2” is “30 seconds”, and a reproduction time of a moving image having the moving image ID “A4” is “20 seconds”. Therefore, the chapter 515 is displayed at two positions, namely “10 seconds” and “40 seconds”. In this regard, the chapter 515 may be displayed on the beginning and the end of the moving image, namely at a position of “0 seconds” and “60 seconds” as illustrated in FIG. 5A and FIG. 5B.

In a message display area 516 in the image 500, a message for complementing contents of a moving image is displayed based on the moving image table 410. For example, when a moving image having the moving image ID “A1” is displayed, a message “Open the right cover” of the data item 415 is displayed in the message display area 516. A message may be hidden after being displayed for a certain period of time or may be displayed while the corresponding moving image is displayed.

An icon 517 in the image 500 indicates a part requiring maintenance in the image forming apparatus 100. In FIG. 5A, since a sheet discharging unit jam has occurred, the icon 517 indicates the sheet discharging unit as a specified part.

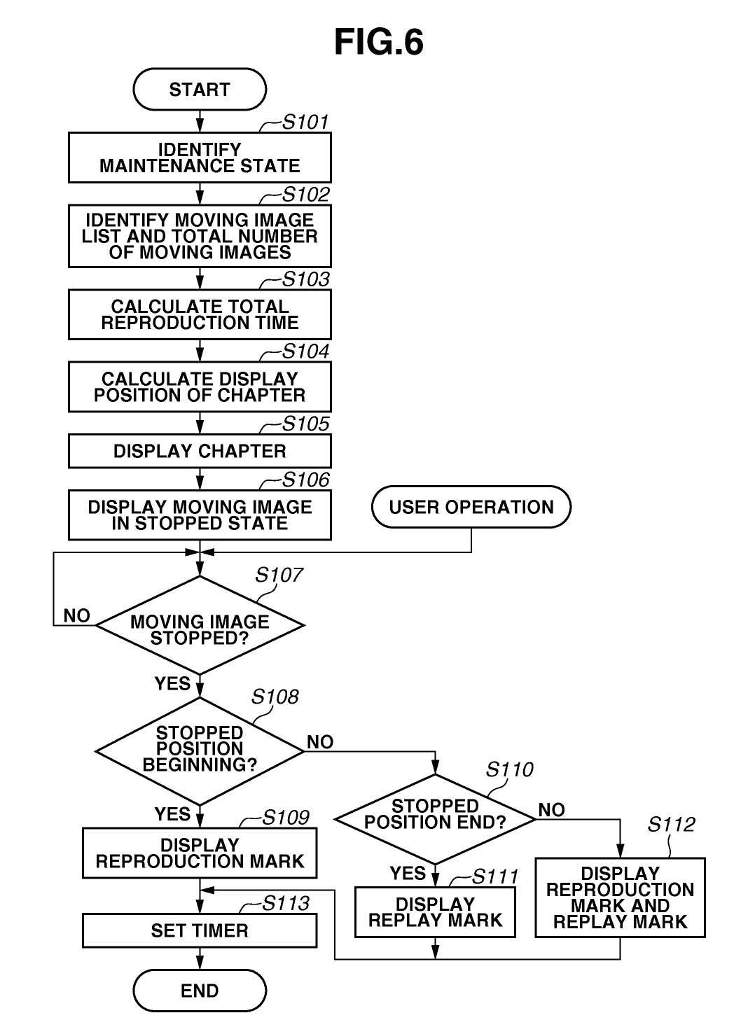

FIG. 6 is a flowchart illustrating processing for presenting a moving image indicating a maintenance procedure performed by the image forming apparatus 100 according to the first exemplary embodiment. The processing in the flowchart is realized by the CPU 101 reading a predetermined program from the storage 111 and executing it. The CPU 101 starts the processing according to detection results from various sensors (including the opening and closing detection sensor of the right cover 201, the opening and closing detection sensor of the toner cover 202, the sheet discharging unit sensor 315, and the double-sided unit sensor 316) which are installed in the printer 106.

In step S101, the CPU 101 identifies a maintenance ID according to a maintenance state which is identified by the printer control unit 105 from the detection results of the various sensors. For example, if the printer control unit 105 identifies stagnation of a sheet near the sheet discharging unit sensor 315 from the detection result of the sheet discharging unit sensor 315, the CPU 101 determines that a sheet discharging unit jam has occurred as maintenance state and identifies the maintenance ID “001”.

In step S102, the CPU 101 identifies a moving image list and a total number of moving images N to be reproduced based on the identified maintenance ID. The CPU 101 searches, for example, a line of the data item 401 of the specified maintenance ID “001” with reference to the moving image list table 400. The CPU 101 identifies the moving image list to be reproduced from the data item 402 in the searched line. Further, the CPU 101 identifies the number of moving image IDs included in the moving image list as the total number of moving images N. In the case of the maintenance ID “001”, the moving image IDs “A1”, “A2”, and “A4” are identified as the moving image list. The total number of moving images N is “three”. The CPU 101 temporarily stores the identified moving image list in the order of reproduction as, for example, arrangement information in the RAM 104.

In step 5103, the CPU 101 calculates a total reproduction time of the moving images after identifying the moving image list and the total number of moving images N. The CPU 101 searches the line of the data item 411 of the moving image ID included in the identified moving image list with reference to the moving image table 410. Based on the data item 413 in the searched line, the CPU 101 obtains a reproduction time of each moving image and calculates the total reproduction time of the moving images by adding them together. The CPU 101 displays the calculated total reproduction time in the reproduction time display label 512.

In step S104, the CPU 101 calculates a display position of the chapter 515 after the calculation of the total reproduction time. The CPU 101 calculates the display position of the chapter 515 from the reproduction times of each of the searched moving images. In step S105, the CPU 101 displays the chapter 515 on the bar 513 according to the calculation result. Each processing in step S103 to step S105 is based on the data item 413, so that the CPU 101 may perform each processing at the same time.

In the case that the moving image table 410 does not include the data item 413, the CPU 101 calculates a reproduction time of a moving image when reading the moving image and calculates a total reproduction time and a display position of the chapter 515. For example, the CPU 101 reads a moving image to the RAM 104 and calculates a reproduction time of the moving image from a frame rate and a total number of frames of the moving image. The CPU 101 calculates reproduction times of a plurality of moving images and calculates a total reproduction time and a display position of the chapter 515.

After displaying the chapter 515, in step S106, the CPU 101 reads a moving image having the moving image ID which is a first one in the reproduction order from the storage 111 and causes the display control unit 114 to display the moving image in a stopped state on the display unit 115. In step S107, the CPU 101 determines whether the moving image is stopped. If the moving image has been stopped (YES in step S107), then in step S108, the CPU 101 determines whether a stopped position of the moving image is a beginning of the moving image. The moving image can also be stopped by a user operating the pause button 506.

If the stopped position of the moving image is the beginning of the moving image (YES in step S108), in step S109, the CPU 101 displays only the reproduction mark 509 by overlapping on the moving image in the moving image display area 501. If the stopped position of the moving image is not the beginning of the moving image (NO in step S108), in step S110, the CPU 101 determines whether the stopped position of the moving image is an end of the moving image. If the stopped position of the moving image is the end of the moving image (YES in step S110), in step S111, the CPU 101 displays only the replay mark 508 by overlapping on the moving image in the moving image display area 501. If the stopped position of the moving image is not the end of the moving image (NO in step S110), in step S112, the CPU 101 displays the replay mark 508 and the reproduction mark 509 by overlapping on the moving image in the moving image display area 501.

Then, in step S113, the CPU 101 sets a timer which starts when a certain period of time elapses and terminates the processing. A time (a certain period of time) when the timer starts may be a value stored in the ROM 102 or the storage 111 in advance of a value input by a user in advance. If the timer is already set, the CPU 101 resets the time when the timer starts.

A compression format and a coder-decoder (Codec) of a moving image are not limited especially in the present exemplary embodiment, and various formats can be employed.

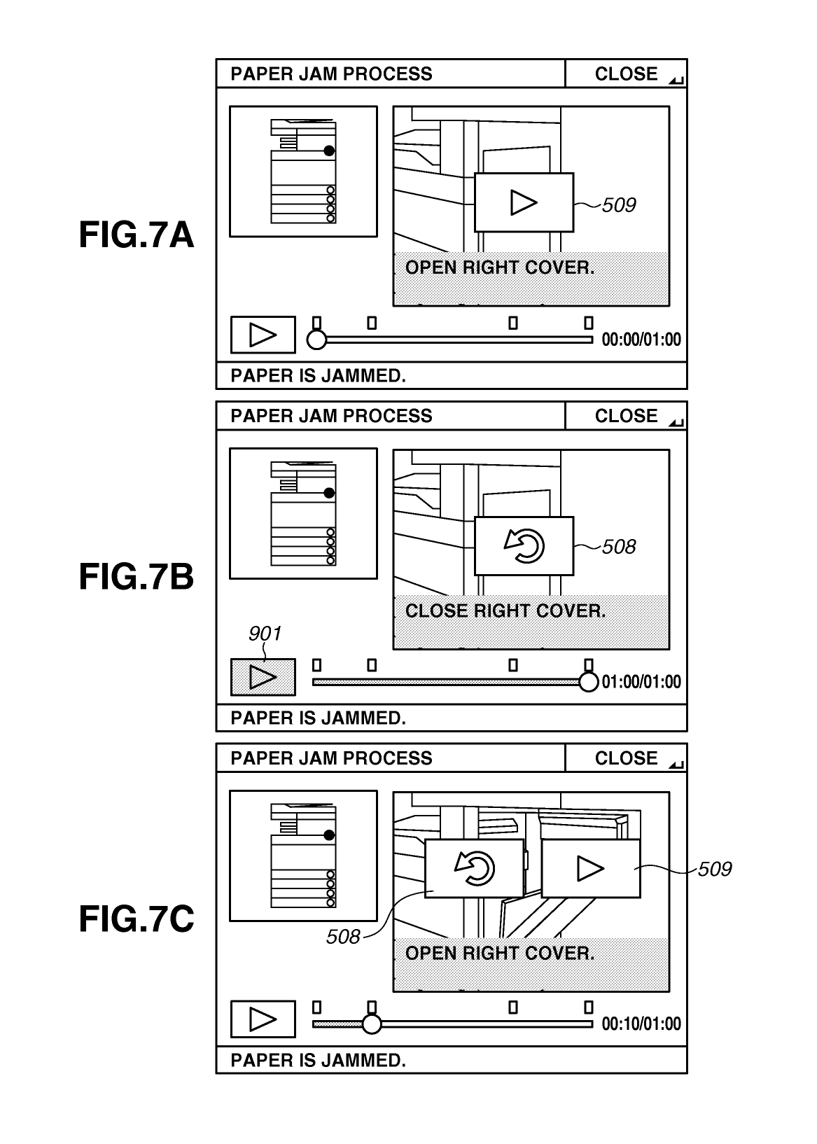

By performing the above-described processing, an operation mark is displayed in the moving image display area 501 of the display unit 115. FIGS. 7A to 7C illustrate display examples of operation marks displayed on the display unit 115. FIG. 7A is a display example when only the reproduction mark 509 is displayed. When the processing in step S109 in FIG. 6 is executed, the CPU 101 displays only the reproduction mark 509 in the moving image display area 501. FIG. 7B is a display example when only the replay mark 508 is displayed. When the processing in step S111 in FIG. 6 is executed, the CPU 101 displays only the replay mark 508 in the moving image display area 501. At that time, the CPU 101 disables an operation of the reproduction button 507 and changes a color thereof. FIG. 7C is a display example when the replay mark 508 and the reproduction mark 509 are displayed. When the processing in step S112 in FIG. 6 is executed, the CPU 101 displays the replay mark 508 and the reproduction mark 509 in the moving image display area 501.

FIGS. 8A-1 to 8B-3 illustrate how an operation mark is hidden. FIGS. 8A-1, 8A-2, and 8A-3 illustrate images when the operation mark is displayed. FIGS. 8B-1, 8B-2, and 8B-3 illustrate images when the operation mark is hidden.

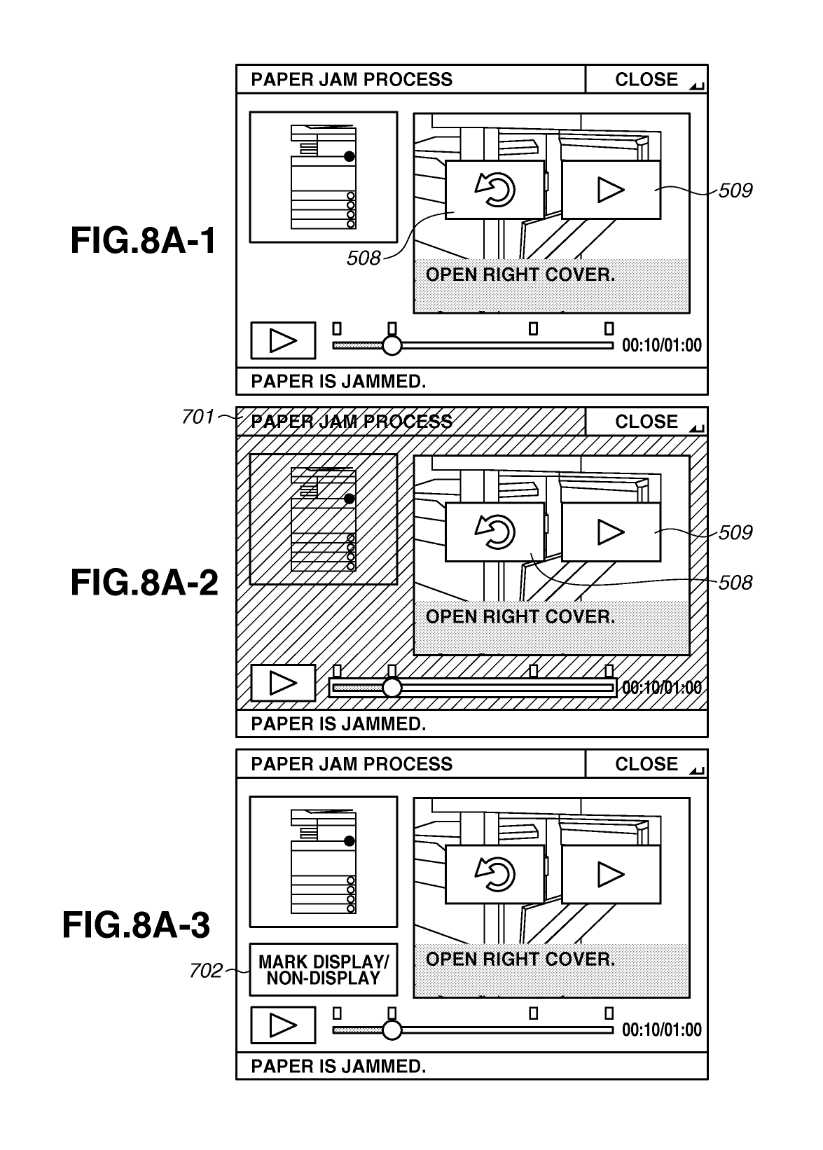

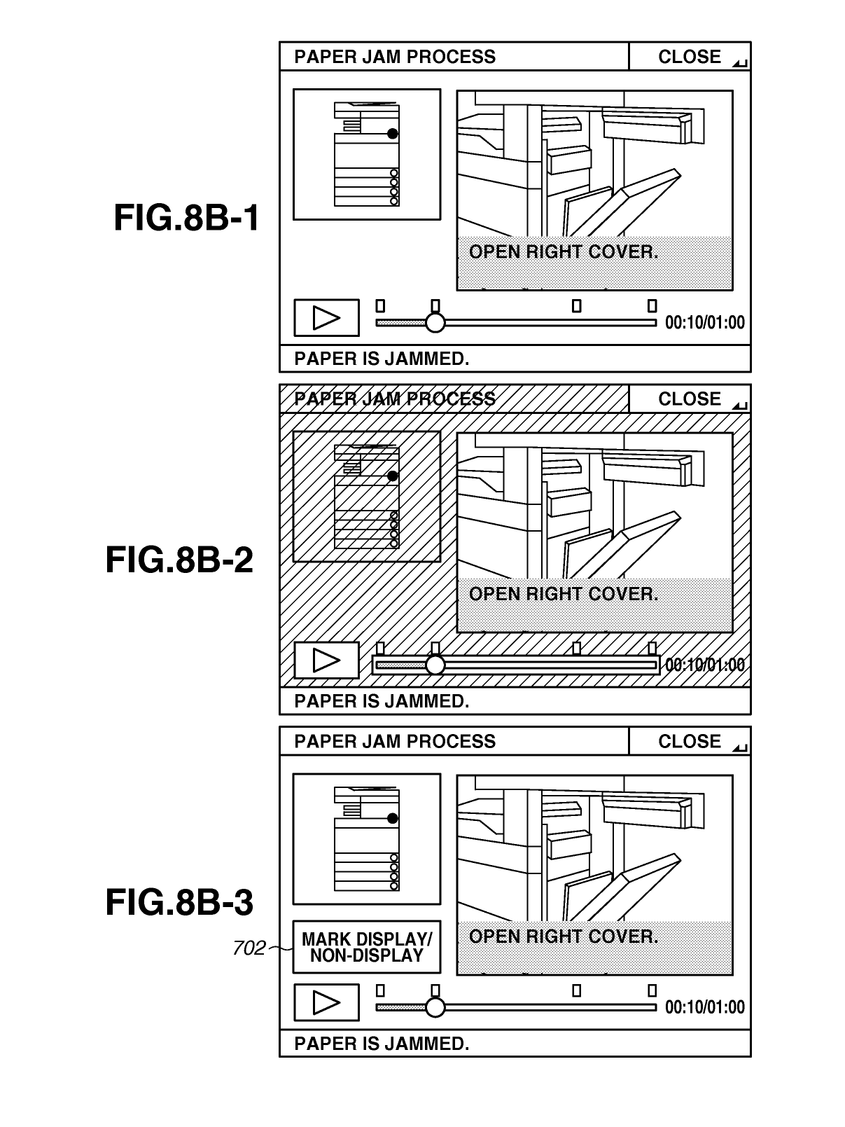

When a certain period of time has elapsed in a state that the image in FIG. 8A-1 is displayed, the CPU 101 hides the operation mark and changes the display to the image in FIG. 8B-1. If a user operates (touches) a shaded area 701 in the image in FIG. 8A-2, the CPU 101 hides the operation mark and changes the display to the image in FIG. 8B-2. The shaded area 701 is an area other than the moving image display area 501 of the display unit 115. If a user operates (presses) a mark display/non-display button 702 in the image in FIG. 8A-3, the CPU 101 hides the operation mark and changes the display to the image in FIG. 8B-3. The mark display/non-display button 702 is a button for switching a display state and a hidden state of the operation mark. As described above, the CPU 101 hides the operation mark when a predetermined condition is satisfied, such as a lapse of a certain period of time, a touch on the shaded area 701, and a touch on the mark display/non-display button 702. Further, the CPU 101 hides the operation mark by a combination of these conditions.

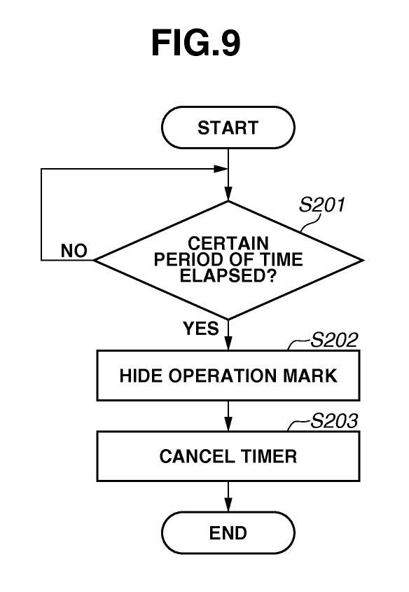

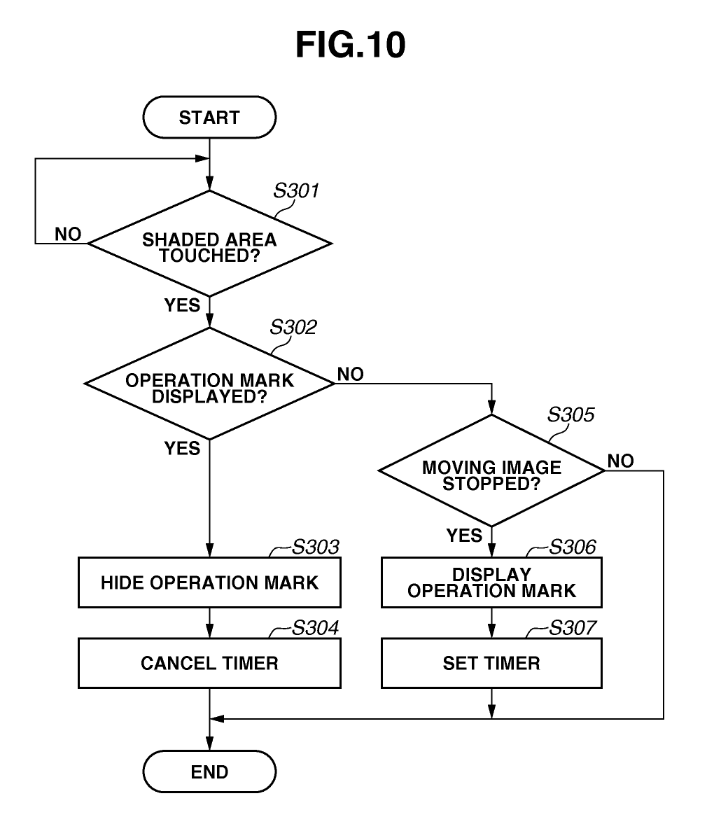

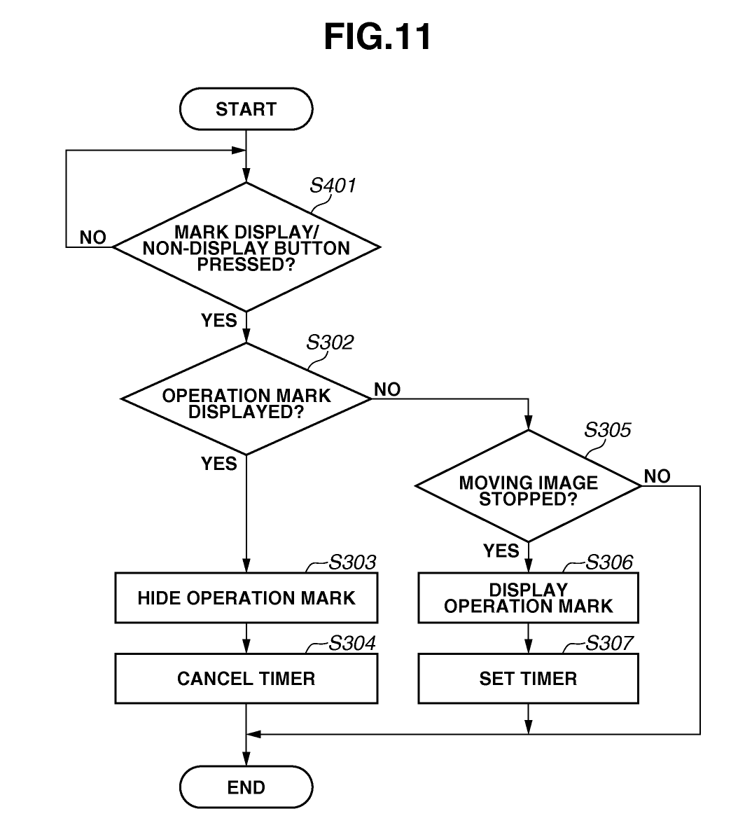

FIG. 9 to FIG. 11 are flowcharts illustrating processing for hiding an operation mark. FIG. 9 illustrates the processing for hiding the operation mark in response to a lapse of a certain period of time (from FIG. 8A-1 to FIG. 8B-1). FIG. 10 illustrates the processing for hiding the operation mark in response to a touch on the shaded area 701 (from FIG. 8A-2 to FIG. 8B-2). FIG. 11 illustrates the processing for hiding the operation mark in response to a touch on the mark display/non-display button 702 (from FIG. 8A-3 to FIG. 8B-3).

According to the processing in FIG. 9, the CPU 101 first determines whether the timer set in step S113 in FIG. 6 has started after a lapse of the certain period of time. Accordingly, in step S201, the CPU 101 can determine whether a certain period of time has elapsed since the image is displayed. If the certain period of time has elapsed (YES in step S201), then in step S202, the CPU 101 hides the operation mark. The CPU 101 stores the hidden operation mark in the RAM 104 or the storage 111. In step S203, the CPU 101 cancels the timer and terminates the processing.

According to the processing in FIG. 10, in step S301, the CPU 101 first determines whether the shaded area 701 is operated (touched) by a user. If the shaded area 701 is operated (YES in step S301), then in step S302, the CPU 101 checks whether the operation mark (the replay mark 508 and/or the reproduction mark 509) is displayed. In the case where the operation mark is displayed (YES in step S302), in step S303, the CPU 101 hides the operation mark. Then, in step S304, the CPU 101 cancels the timer and terminates the processing. The CPU 101 stores the hidden operation mark in the RAM 104 or the storage 111.

In the case where the operation mark is not displayed (NO in step S302), in step S305, the CPU 101 determines whether the moving image is in a stopped state. If the moving image is not in the stopped state (NO in step S305), the CPU 101 directly terminates the processing. If the moving image is in the stopped state (YES in step S305), in step S306, the CPU 101 displays the operation mark. Then, in step S307, the CPU 101 sets the timer and terminates the processing. The operation mark to be display is the one stored in the RAM 104 and the storage 111 when being hidden. The operation mark may be displayed by, for example, performing the processing in step S108 to step S112 again.

According to the processing in FIG. 11, in step S401, the CPU 101 first determines whether the mark display/non-display button 702 is operated (pressed) by a user. If the mark display/non-display button 702 is operated (YES in step S401), the CPU 101 performs processing similar to the processing in step S302 and the subsequent steps in FIG. 10 and hides the operation mark.

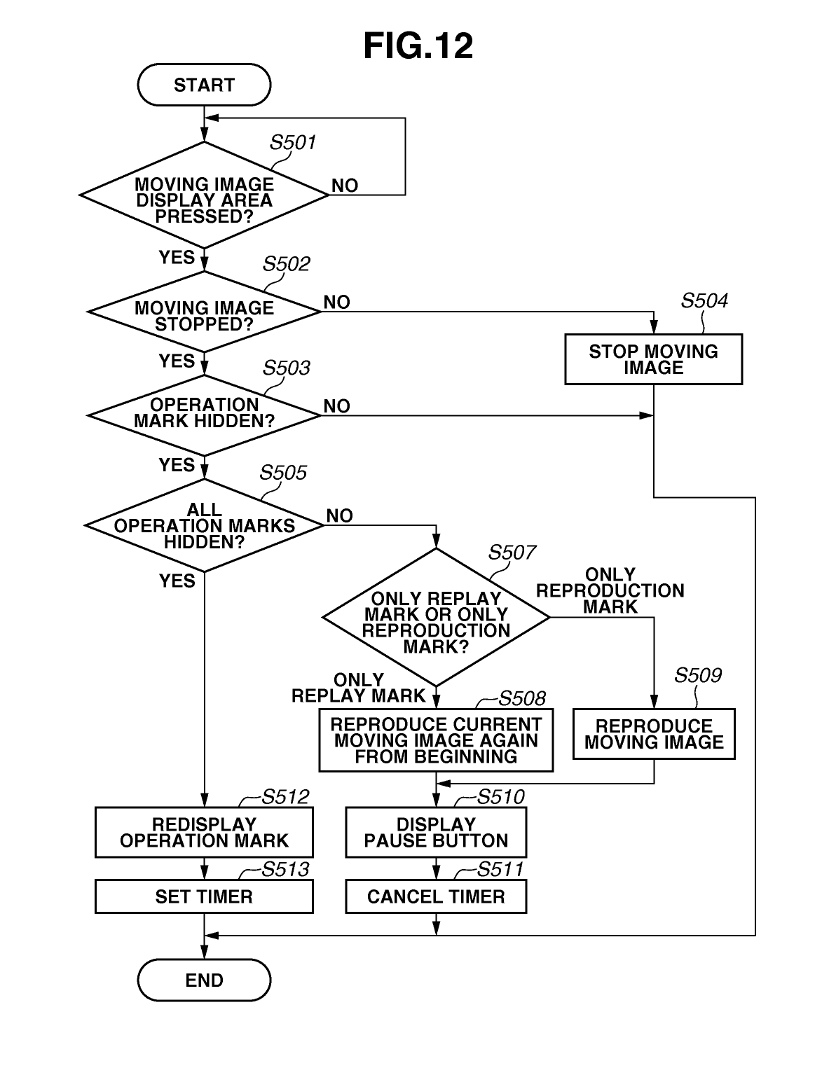

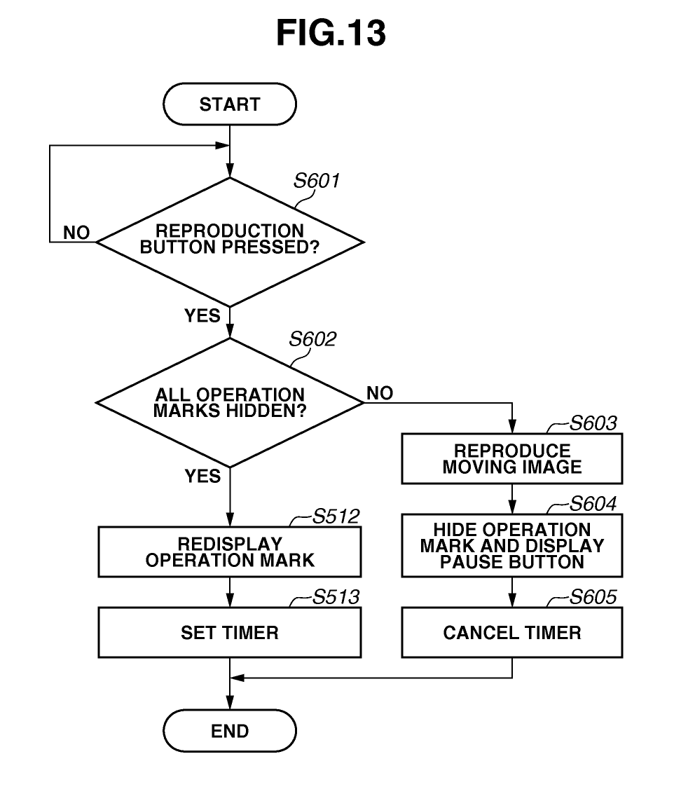

FIG. 12 and FIG. 13 are flowcharts illustrating processing for redisplaying the operation mark hidden by the processing in FIG. 9 to FIG. 11. The processing in each flowchart is realized by the CPU 101 reading a predetermined program from the storage 111 and executing it. The image forming apparatus 100 can redisplay the operation mark by either of the processing in FIG. 12 or FIG. 13 when the operation mark is hidden.

According to the processing in FIG. 12, the operation mark is redisplayed when a user operates (presses) the moving image display area 501.

In step S501, if the CPU 101 detects that the moving image display area 501 of the display unit 115 is pressed by a user (YES in step S501), then in step S502, the CPU 101 determines whether the moving image is stopped. If the moving image is not stopped (NO in step S502), in step S504, the CPU 101 stops the moving image and terminates the processing. If the moving image is stopped (YES in step S502), then in step S503, the CPU 101 determines whether at least one of the replay mark 508 and the reproduction mark 509, which are the operation marks, is hidden. If both of the operation marks are not hidden (NO in step S503), the CPU 101 terminates the processing.

If at least one of the operation marks is hidden (YES in step S503), then in step S505, the CPU 101 determines whether all of the operation marks (the replay mark 508 and the reproduction mark 509) are hidden. If all of the operation marks are hidden (YES in step S505), in step S512, the CPU 101 redisplays the all operation marks (the replay mark 508 and the reproduction mark 509). After displaying the operation marks, in step S513, the CPU 101 set the timer and terminates the processing.

If the operation mark is displayed, in other words, if any one of the replay mark 508 and the reproduction mark 509 is displayed (NO in step S505), in step S507, the CPU 101 determines which one of the replay mark 508 and the reproduction mark 509 is displayed. If the replay mark 508 is displayed (“ONLY REPLAY MARK” in step S507), in step S508, the CPU 101 reproduces the moving image currently stopped again from the beginning. If the reproduction mark 509 is displayed (“ONLY REPRODUCTION MARK” in step S507), in step S509, the CPU 101 reproduces the moving image. After reproducing the moving image, in step S510, the CPU 101 displays the pause button 506. Then, in step S511, the CPU 101 cancels the timer and terminates the processing.

According to the processing in FIG. 13, when a user operates (presses) the reproduction button 507, the operation mark is redisplayed.

In step S601, when the CPU 101 detects that the reproduction button 507 on the display unit 115 is pressed by a user (YES in step S601), then in step S602, the CPU 101 determines whether all of the operation marks (the replay mark 508 and the reproduction mark 509) are hidden. If all of the operation marks are hidden (YES in step S602), the CPU 101 performs processing similar to the processing in steps S512 and S513 in FIG. 12 and terminates the processing.

If the operation mark is displayed, in other words, if at least one of the replay mark 508 and the reproduction mark 509 is displayed (NO in step S602), then in step S603, the CPU 101 reproduces the moving image. After reproducing the moving image, in step S604, the CPU 101 hides the operation mark and displays the pause button 506. Then, in step S605, the CPU 101 cancels the timer and terminates the processing.

As described above, according to the present exemplary embodiment, an operation mark is displayed on an explicit and easy-to-understand position on the display unit 115, and display and non-display of the operation mark can be switched by an operation of the timer, the shaded area 701, and the mark display/non-display button 702. Therefore, operability can be improved on both users who does not positively operates a moving image regularly and who carefully confirms display contents by stopping the moving image.

According to a second exemplary embodiment, an operation mark is redisplayed in response to an input of a job even if the operation mark is hidden in a situation in which a user cannot confirm the display unit 115. The image forming apparatus 100 according to the second exemplary embodiment for performing such processing includes the configuration similar to that in the first exemplary embodiment, so that the descriptions thereof are omitted.

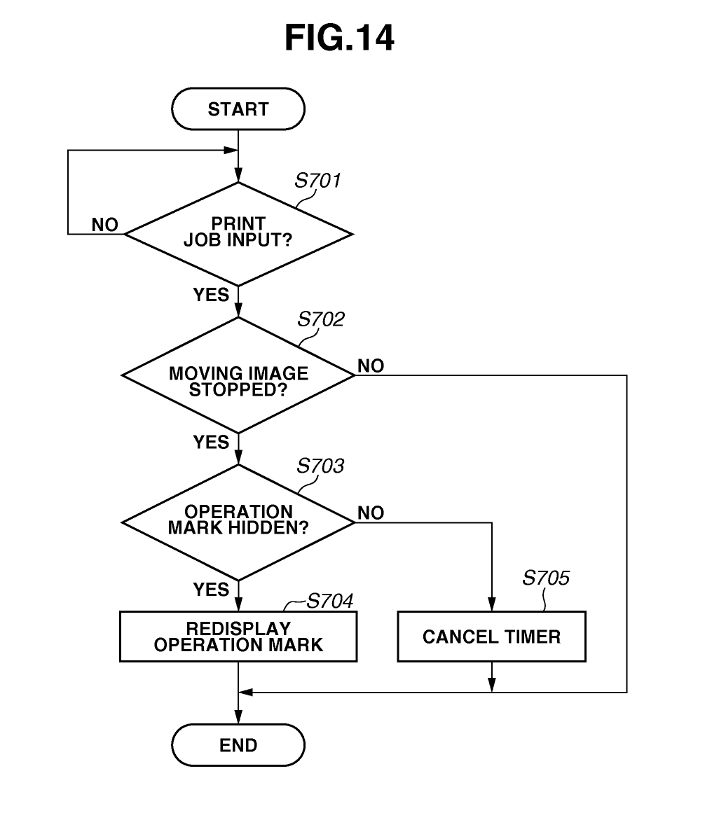

FIG. 14 is a flowchart illustrating processing for redisplaying an operation mark in response to an input of a print job. The processing in the flowchart is realized by the CPU 101 reading a predetermined program from the storage 111 and executing it.

In step S701, the CPU 101 causes the job management unit 116 to check whether a print job is input or not. If a print job is input (YES in step S701), in step S702, the CPU 101 determines whether a moving image is in a stopped state. If the moving image is not in the stopped state (NO in step S702), the CPU 101 terminates the processing.

If the moving image is in the stopped state (YES in step S702), then in step S703, the CPU 101 determines whether the operation mark (the replay mark 508 and/or the reproduction mark 509) is displayed. If at least one of the operation mark is not displayed (YES in step S703), in step S704, the CPU 101 displays the hidden operation mark again on the display unit 115. After redisplaying the operation mark, the CPU 101 terminates the processing. If all of the operation marks are displayed (NO in step S703), in step S705, the CPU 101 cancels the timer and terminates the processing.

The CPU 101 does not set the timer after redisplaying the operation mark in step S704. Since the timer is not set, the operation mark is not automatically cleared until a user who has input a print job comes to the image forming apparatus 100 to pick up a printed material as a result of the print job. In addition, prior to the processing in step S113 in FIG. 6 according to the first exemplary embodiment, presence or absence of an input of a job may be determined (processing similar to that in step S701), and if there is a job, the timer may not be set.

According to the above-described second exemplary embodiment, if an operation mark is hidden in a situation in which a user cannot confirm the display unit 115, the operation mark can be redisplayed by an input of a job. Therefore, the operation mark can be explicitly presented to a user when the user comes to the image forming apparatus 100 to pick up a result (printed material) of a job.

According to a third exemplary embodiment, display and non-display of an operation mark is switched by an operation on a hard key provided for the input unit 113. The image forming apparatus 100 according to the third exemplary embodiment for performing such processing includes the configuration similar to that in the first exemplary embodiment, so that the descriptions thereof are omitted.

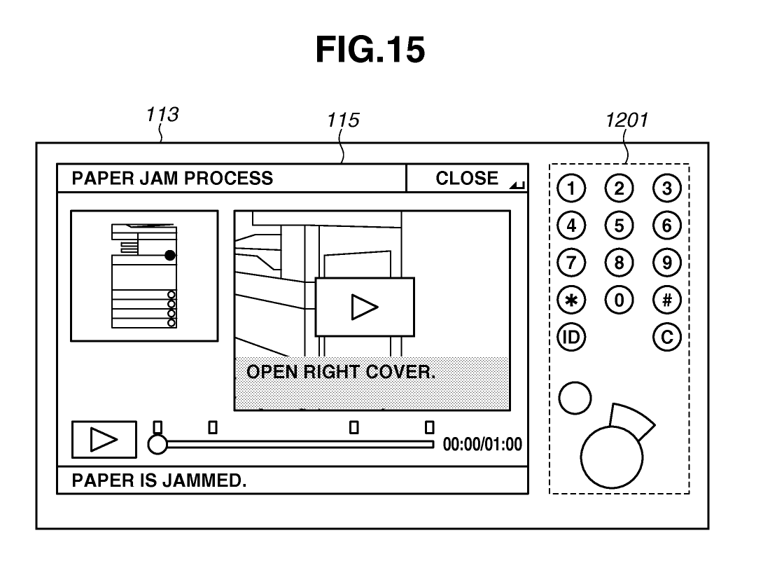

FIG. 15 is an outline view of the input unit 113. The input unit 113 is formed by being integrated with the display unit 115 which is a touch panel, and includes a hard key 1201. The CPU 101 switches display and non-display of the operation mark if any key in the hard key 1201 is pressed. As for a pressed key, all or a part of the keys in the hard key 1201 may be a target of switching the display and non-display. Further, instead of the hard key 1201, a keyboard connected to the image forming apparatus 100 may be used.

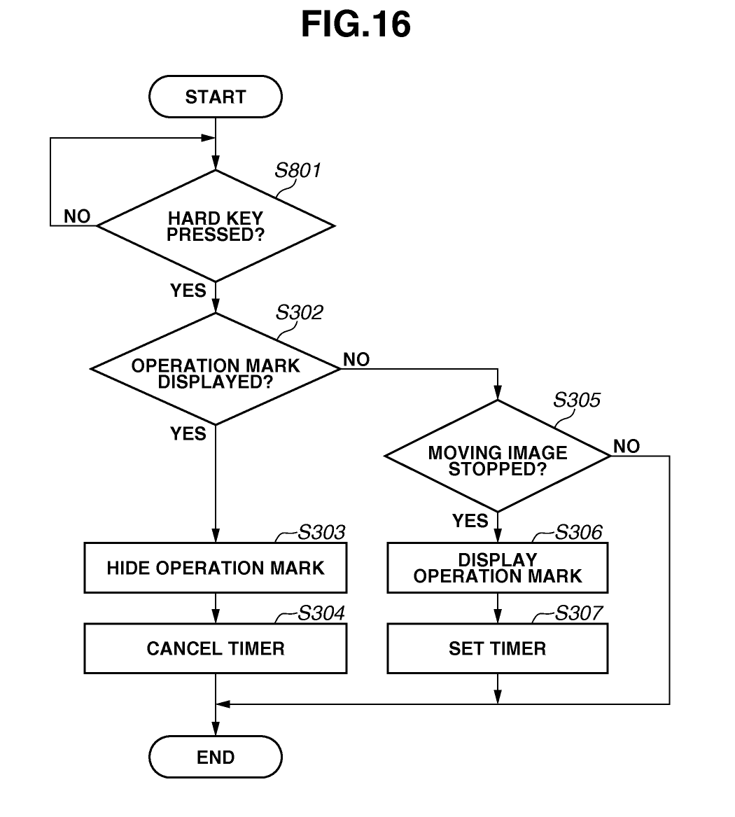

FIG. 16 is a flowchart illustrating processing for switching display and non-display of an operation mark in response to pressing of the hard key 1201 in the input unit 113. The processing in the flowchart is realized by the CPU 101 reading a predetermined program from the storage 111 and executing it.

In step S801, the CPU 101 determines whether the hard key 1201 in the input unit 113 is pressed. If the hard key 1201 is pressed (YES in step S801), the CPU 101 executes the processing similar to the processing in step S302 and the subsequent steps in FIG. 10 and switches display and non-display of the operation mark.

According to the above-described third exemplary embodiment, if an operation mark is hidden, the operation mark can be redisplayed by pressing the hard key 1201. To the contrary, if a user wants to hide the operation mark, the operation mark can be hidden by pressing the hard key 1201. Therefore, a user can switch display and non-display of the operation mark on his or her own will.

According to a fourth exemplary embodiment, a selection window for switching display and non-display of an operation mark is displayed by pressing the operation mark long (i.e., a long press of the operation mark). Thus, a user can switch display and non-display of the operation mark by the selection window. The selection window is a pop-up image to be displayed by a long press of the operation mark. The image forming apparatus 100 according to the fourth exemplary embodiment for performing such processing includes the configuration similar to that in the first exemplary embodiment, so that the descriptions thereof are omitted.

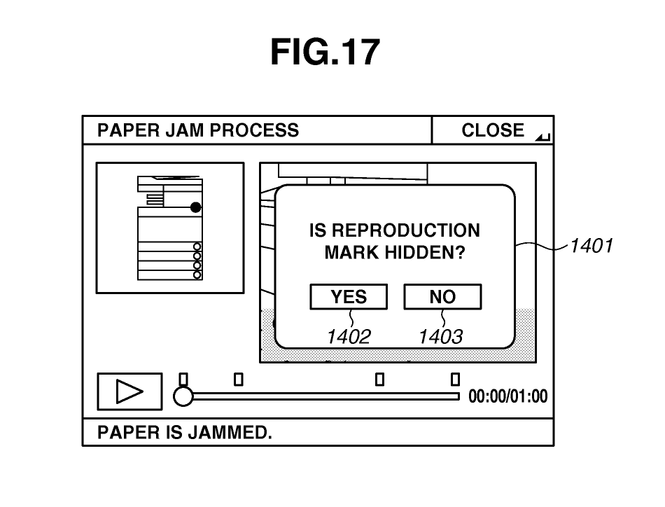

FIG. 17 illustrates an example of a selection window. When detecting a long press of the reproduction mark 509, for example, the CPU 101 displays a selection window 1401 on the display unit 115. In the selection window 1401, a sentence for asking whether a user wants to hide the reproduction mark 509, and an option 1402 of a positive answer and an option 1403 of a negative answer to the question are displayed. In addition, a sentence for asking whether a user wants to hide the replay mark 508, and an option of a positive answer and an option of a negative answer to the question may be displayed at the same time. Further, only the sentence for asking whether a user wants to hide the replay mark 508, and the option of a positive answer and the option of a negative answer to the question may be displayed. If both of the replay mark 508 and the reproduction mark 509 are displayed, the selection window 1401 for asking display and non-display of the operation mark which is pressed long may be displayed or the selection window 1401 for asking display and non-display of both operation marks may be displayed.

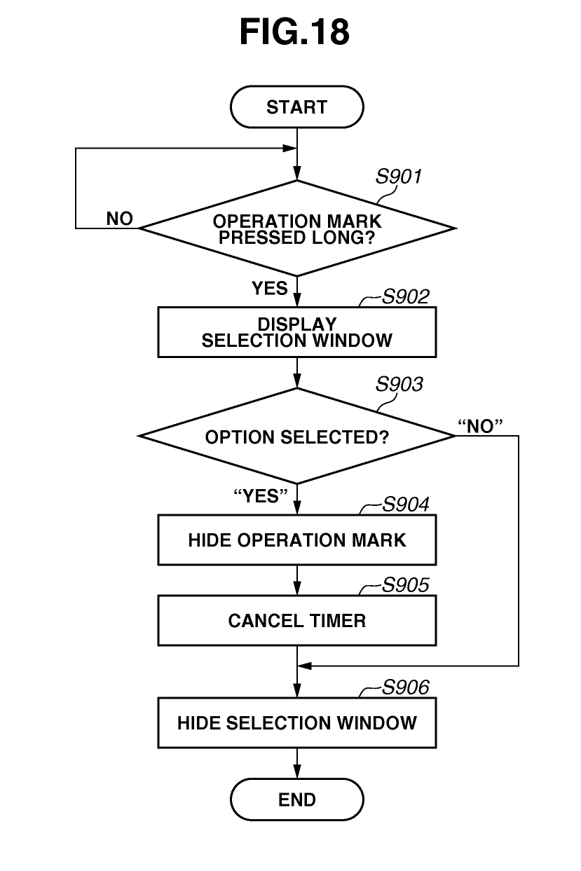

FIG. 18 is a flowchart illustrating processing for switching display and non-display of an operation mark using the selection window 1401. The processing in the flowchart is realized by the CPU 101 reading a predetermined program from the storage 111 and executing it.

In step S901, the CPU 101 detects whether a user presses the operation mark (the replay mark 508 or the reproduction mark 509) long. If a long press is detected (YES in step S901), in step S902, the CPU 101 displays the selection window 1401 in the moving image display area 501 of the display unit 115.

In step S903, the CPU 101 determines which option 1402 or 1403 in the selection window 1401 is pressed by the user. If the option 1403 of “NO” is pressed (selected) (“NO” in step S903), then in step S906, the CPU 101 hides the selection window 1401 and terminates the processing. If the option 1402 of “YES” is pressed (selected) (“YES” in step S903), then in step S904, the CPU 101 hides the operation mark, and in step S905, cancels the timer. The operation mark to be hidden is the operation mark pressed long by the user in step S901 or all operation marks being displayed. After hiding the operation mark, in step S906, the CPU 101 hides the selection window 1401 and terminates the processing.

According to the above-described fourth exemplary embodiment, an operation mark is displayed on an explicit and easy-to-understand place. Further, when the operation mark is pressed long, the selection window 1401 for hiding the operation mark is displayed. Accordingly, a method for improving operability of both users who does not positively operates a moving image regularly and who carefully confirms display contents by stopping the moving image can be provided.

According to a fifth exemplary embodiment, display and non-display of an operation mark is switched by dragging the operation mark by a user. The image forming apparatus 100 according to the fifth exemplary embodiment for performing such processing includes the configuration similar to that in the first exemplary embodiment, so that the descriptions thereof are omitted.

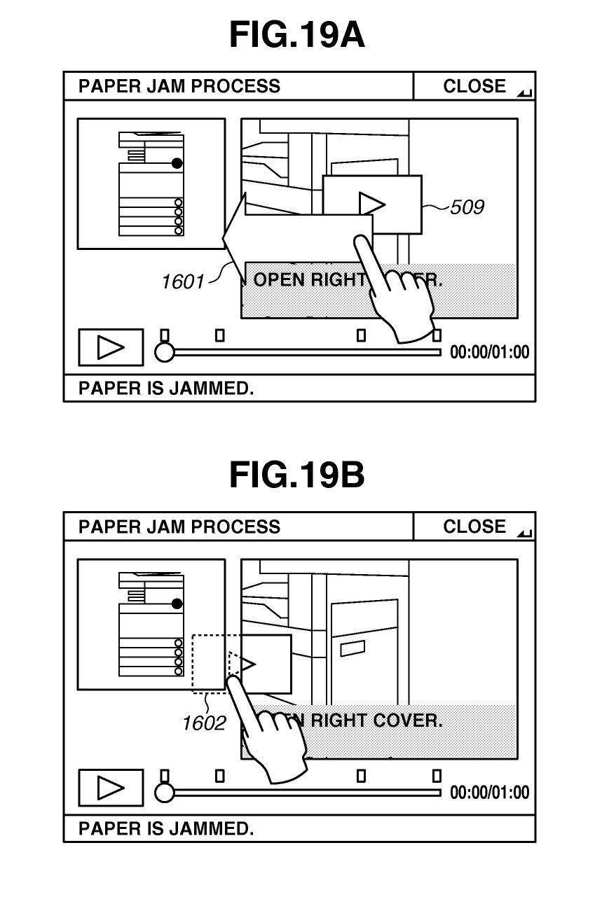

FIGS. 19A and 19B illustrate a drag operation of an operation mark. FIG. 19A illustrates a state when the reproduction mark 509 is dragged to the left of the drawing. The reproduction mark 509 is moved to a direction indicated by an arrow 1601 by the drag. FIG. 19B illustrates a state after the reproduction mark 509 is dragged. The reproduction mark 509 is displayed on a position 1602. A portion drawn by broken lines in the position 1602 is a hidden portion of the reproduction mark 509. A portion which protrudes from the moving image display area 501 in the reproduction mark 509 is hidden.

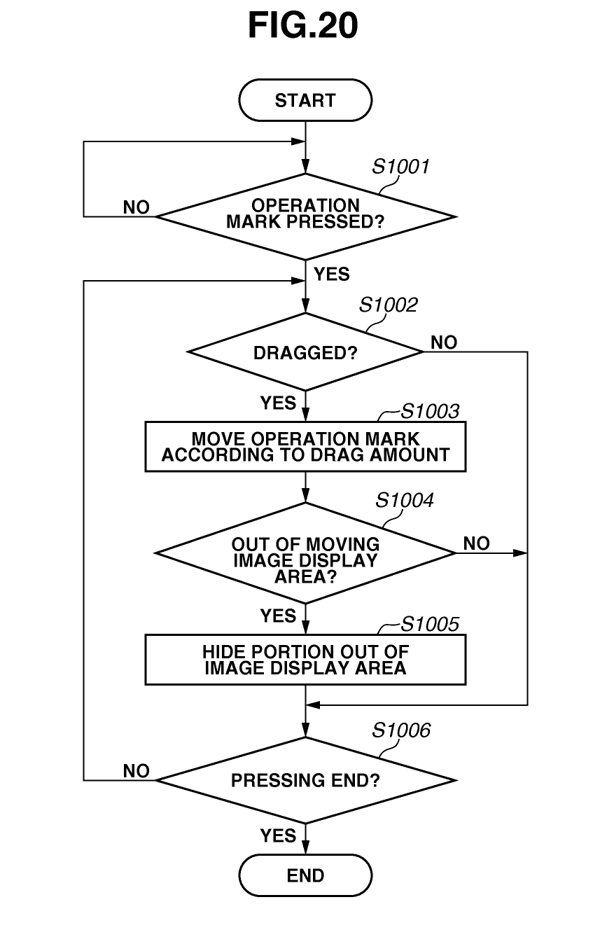

FIG. 20 is a flowchart illustrating processing for switching display and non-display of an operation mark by a drag of the operation mark. The processing in the flowchart is realized by the CPU 101 reading a predetermined program from the storage 111 and executing it.

In step S1001, the CPU 101 determines whether the operation mark (the replay mark 508 or the reproduction mark 509) is pressed. If the operation mark has been pressed (YES in step S1001), in step S1002, the CPU 101 determines whether the operation mark is dragged from the pressed state. If the operation mark has been dragged (YES in step S1002), then in step S1003, the CPU 101 moves the operation mark according to a movement amount (operation amount) by the drag.

In step S1004, the CPU 101 determines whether the moved operation mark protrudes from the moving image display area 501. If the operation mark protrudes therefrom (YES in step S1004), in step S1005, the CPU 101 hides a portion of the operation mark which protrudes from the moving image display area 501.

In the case where the operation mark is not dragged (NO in step S1002), in the case where the operation mark has not protruded from the moving image display area 501 (NO in step S1004), and in the case where the protruded portion is hidden, then in step S1006, the CPU 101 determines whether the pressed state is ended. If the pressed state is not ended (NO in step S1006), the CPU 101 repeats the processing from step S1002. If the pressed state is ended (NO in step S1006), the CPU 101 terminates the processing.

According to the above-described fifth exemplary embodiment, an operation mark is displayed on an explicit and easy-to-understand place. In addition, the operation mark can be hidden by being dragged. Accordingly, a method for improving operability of both users who does not positively operates a moving image regularly and who carefully confirms display contents by stopping the moving image can be provided.

Thus, display and non-display of an operation mark can be switched by various combination of the above-described first to fifth exemplary embodiments. Further, processing can be performed according to the operation mark operated by a user.

As described above, according to each of the above exemplary embodiments, an operation mark can be explicitly displayed on a position easy to understand by being overlapped with a moving image. The operation mark can be switched to be displayed or to be hidden. Therefore, a moving image indicating a maintenance procedure can be presented to any user without impairing the operability.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-260436, filed Dec. 17, 2013, which is hereby incorporated by reference herein in its entirety.

What is claimed is:

1. An image forming apparatus comprising:
a display unit configured to display a moving image indicating a maintenance procedure;
an overlapping display unit configured to, in a case where the moving image is stopped, display one or more operation marks for operating the stopped moving image on the display unit by overlapping with the moving image;
a hiding unit configured to hide all of the operation marks in a case where a predetermined condition is satisfied during when the operation mark is displayed; and
a control unit configured to, in a case where all of the operation marks are hidden during when the moving image is stopped, redisplay the one or more operation marks by the overlapping display unit in response to a user operation, and in a case where one operation mark is displayed during when the moving image is stopped, operate the stopped moving image according to the operation mark in response to a user operation.

2. The image forming apparatus according to claim 1 further comprising:
a unit configured to set a timer which starts when a certain period of time elapses from display of the operation mark, and
wherein the hiding unit hides the operation mark when the timer starts during when the moving image is stopped.

3. The image forming apparatus according to claim 1,
wherein the display unit includes a moving image display area on which the moving image is displayed,
wherein, in a case where the operation mark is displayed during when the moving image is stopped, the hiding unit hides the operation mark in response to an operation performed on an area excepting the moving image display area, and
in a case where all of the operation marks are hidden during when the moving image is stopped, the control unit redisplays the one or more operation marks on the overlapping display unit in response to an operation performed on an area excepting the moving image display area.

4. The image forming apparatus according to claim 3,
wherein, in a case where all of the operation marks are hidden during when the moving image is stopped, the control unit redisplays the one or more operation marks on the overlapping display unit in response to an operation performed on the moving image display area, and in a case where one operation mark is displayed during when the moving image is stopped, the control unit operates the stopped moving image according to the operation mark in response to an operation performed on the moving image display area.

5. The image forming apparatus according to claim 1,
wherein the display unit displays a mark display/non-display button for switching a display state and a non-display state of the operation mark,
wherein, in a case where the operation mark is displayed during when the moving image is stopped, the hiding unit hides the operation mark in response to an operation performed on the mark display/non-display button, and
in a case where all of the operation marks are hidden during when the moving image is stopped, the control unit redisplays the one or more operation marks on the overlapping display unit in response to an operation performed on the mark display/non-display button.

6. The image forming apparatus according to claim 1,
wherein the display unit displays a reproduction button for reproducing the moving image, and
wherein, in a case where all of the operation marks are hidden during when the moving image is stopped, the control unit redisplays the one or more operation marks on the overlapping display unit in response to an operation performed on the reproduction button, and in a case where one operation mark is displayed during when the moving image is stopped, the control unit operates the stopped moving image according to the operation mark in response to an operation performed on the reproduction button.

7. The image forming apparatus according to claim 1 further comprising:
a job management unit configured to manage a job to be processed, and
wherein, in a case where all of the operation marks are hidden during when the moving image is stopped, the control unit redisplays the one or more operation marks on the overlapping display unit in response to confirming an input of the job by the job management unit.

8. The image forming apparatus according to claim 1 further comprising:
an input unit including a hard key,
wherein, in a case where the operation mark is displayed during when the moving image is stopped, the hiding unit hides the operation mark in response to an operation performed on the hard key, and
in a case where all of the operation marks are hidden during when the moving image is stopped, the control unit redisplays the one or more operation marks on the overlapping display unit in response to an operation performed on the hard key.

9. The image forming apparatus according to claim 1,
wherein, in a case where the operation mark is displayed during when the moving image is stopped and the operation mark is pressed long, the control unit displays a pop-up image for switching display and non-display of the operation mark on the overlapping display unit and switches the display and non-display of the operation mark according to an input by the pop-up image.

10. The image forming apparatus according to claim 1,
wherein the display unit includes a touch panel, and
wherein, in a case where the operation mark is displayed during when the moving image is stopped, the hiding unit hides the operation mark according to an operation amount of the operation mark operated by a user on the touch panel.

11. The image forming apparatus according to claim 1,
wherein the operation mark is at least one of a reproduction mark for instructing reproduction of a stopped moving image in response to a user operation and a replay mark for reproducing a stopped moving image from a beginning thereof again in response to a user operation.

12. A method executed by an apparatus including a display for displaying a moving image indicating a maintenance procedure, the method comprising:
displaying, in a case where the moving image is stopped, one or more operation marks for operating the stopped moving image on the display by overlapping with the moving image;
hiding all of the operation marks in a case where a predetermined condition is satisfied during when the operation mark is displayed; and
redisplaying, in a case where all of the operation marks are hidden during when the moving image is stopped, the one or more operation marks by the display in response to a user operation, and operating, in a case where one operation mark is displayed during when the moving image is stopped, the stopped moving image according to the operation mark in response to a user operation.

13. A non-transitory computer-readable storage medium storing a computer program for causing a computer including a display for displaying a moving image indicating a maintenance procedure to function as:
an overlapping display unit configured to, in a case where the moving image is stopped, display one or more operation marks for operating the stopped moving image on the display by overlapping with the moving image;
a hiding unit configured to hide all of the operation marks in a case where a predetermined condition is satisfied during when the operation mark is displayed; and
a control unit configured to, in a case where all of the operation marks are hidden during when the moving image is stopped, redisplay the one or more operation marks by the overlapping display unit in response to a user operation, and in a case where one operation mark is displayed during when the moving image is stopped, operate the stopped moving image according to the operation mark in response to a user operation.
